(19) United States
(12) Patent Application Publication
(10) Pub. No.: US 2022/0139361 A1
(43) Pub. Date: May 5, 2022

(54) MXTZ (Music Exponentially Transformed Through Time)

(71) Applicant: James Alex Warner, Johns Creek, GA (US)

(72) Inventor: James Alex Warner, Johns Creek, GA (US)

(21) Appl. No.: 17/086,413

(22) Filed: Nov. 1, 2020

(51) Int. Cl. G10D 9/06

(52) U.S. Cl. CPC G10D 9/06; G10H 2250/055; G10H 2250/005

(57) ABSTRACT

Music instrument and information digital mute system, for capture, processing, and conversion of sound from analog to digital signals using central processing unit (CPU) microcontroller, Bluetooth and Wi-Fi microcontrollers, sound image localization filter, global positioning and geographic information systems, universal serial bus (USB) module, and battery. Mute body is positioned in close proximity to bell or horn, body and/or voice at proximal end and/or configured to occlude sound source. Acoustically designed inner chamber within mute body captures acoustical variations of air pressure. Microphone positioned at distal end of mute, and proximal end of CB position in mute with digital signal processor (DSP) that captures, processes, converts, and transmits digital sound and data. CPU manages and controls components and modules of CB. Bluetooth and Wi-Fi microcontrollers configured to receive and send signals to and from other technological devices, components, and systems (cellphones, tablets, computers, earplugs, smart televisions, server, and cloud platforms). USB module configured to receive and send digital signals, supply power to CB, and charge and recharge battery.

### CROSS REFERENCE TO RELATED APPLICATIONS

This document claims benefit of priority to U.S. Provisional patent application Ser. No. 15/005,914, filed 25 Jan. 2016 and entitled, THE INTEGRATED SMART SILENCER MUTE SYSTEM-MXTZ FOR PRACTICE & PERFORMANCE, the entire disclosure of which hereby incorporated by this reference.

Conventionally, as described in the Japanese Patent Publication Nos. 4114171 and 4124236, it has been well known that a mute (silencer) is attached to the bell of a brass instrument such as a trumpet to reduce (mute) the volume of frequencies, volume, and intensity of sounds emitted from the instrument into the external environment of the instrument. With a microphone embedded into the mute, a player of the instrument can listen to sounds collected by the microphone through earphones as the sounds are emitted from the instrument.

As described in the Japanese Patent Publication No. 4521778 and Japanese Utility Model Registration No. 3145588, it has been well known that a woodwind instrument such as a saxophone can house a mute (silencer) within the bell of the instrument to reduce (mute) the volume of frequencies, volume, and intensity of sounds emitted from the instrument into the external environment of the instrument. With a microphone embedded into the mute, a player of the instrument can listen to sounds collected by the microphone through earphones as the sounds are emitted from the instrument.

Japanese Unexamined Patent Publication No. 11-52836 discloses an art of resolving the difference in localization of sound image between a case where sounds reproduced by earphones are localized inside a head of a player, more specifically, where a player listens to sounds supplied by a microphone embedded within a mute (silencer) through earphones as sound of a musical instrument as described above, and a case where the wind instrument is played without the mute. In the art, electrical signals supplied from the microphone embedded within the mute are processed by a sound image localization filter which performs convolution operation on the electrical signals so that the player of the instrument can listen to sounds of the instrument at a position of sound localization of the case where the wind instrument is played without the mute.

Furthermore, U.S. Pat. No. 9,251,744 B4 discloses and art of resolving distortion or disadvantageous noises from the wind instrument and mute collected through the embedded microphone. In the art, the invention to provides a signal processor for use in the musical performance of a wind instrument using a mute for reducing volume of a sound generated by the wind instrument. The signal processor included a signal processing circuit which received an electrical signal. The signal processor cancelled, converted, and processed specific frequency characteristics of the sound caused by the instrument and mute which then facilitated the output of a processed electrical signal.

As described in Provisional application No. 62/107,233 filed Jan. 2016 and entitled ELECTRONIC MUTE FOR MUSICAL INSTRUMENT discloses a musical instrument mute, a mute body, a microphone, a speaker, and a microcontroller for electronic modification of sound emitted from a musical instrument. A mute body that is positioned within a bell or horn of the musical instrument, and the body has a proximal end portion and is configured to at least partially occlude the bell or horn. A microphone is positioned at the proximal end portion of the mute body and is configured to transduce a sound produced by the musical instrument. A speaker is positioned in the mute body as well. A microcontroller is configured to receive a signal from the microphone and to electronically modify the sound of the instrument when emitted through the speaker. Some mutes also provide a communication transceiver, sensors, and input devices to control and manipulate sound produced by the mute.

### TECHNICAL FIELD

The present disclosure generally relates to a mute device for instruments (woodwind: flute, clarinet, oboe, english horn, saxophone, bassoon; brass: trumpet, cornet, horn, trombone, baritone, euphonium, tuba; Strings: violin, viola, cello, bass; percussion), and voices for use during music practice and performance while reducing the volume of sounds generated by the music instrument and voice (acoustical frequencies and sounds of the music instrument and voice) while converting analog sounds to digital. The sounds are then transmitted via Bluetooth and Wi-Fi across wireless networks and the internet to mobile cellular phone applications and online networks for integration into operating systems, and software and server applications.

Conventional mutes are limited in their ability to create an acoustically balanced sound properties (tone, intonation, pitch, timbre) to connect and integrate with technological devices (earphone and ear buds, mobile phone applications, software on tablet, laptop, and personal computers; monitors and smart televisions, platform as a service [PaaS], Servers, and cloud platforms). It is very difficult for musician or user to be able to achieve acoustically balanced sound properties in mute devices while changing or manipulating the sound and/or volume and intensity. There is also limited or no access mute devices that connect or integrate to technological devices. Therefore, there is a present need for improvement in music mute devices and connection and integration in technological devices.

### SUMMARY OF THE INVENTION

As in the cases of the conventional arts disclosed in the above-described Japanese Patent Publication Nos. 4114171, 4124236, 4521778, and Japanese Utility Model Registration No. 3145588; however, when a player listens to sounds of a wind instrument supplied from a microphone embedded in a mute through earphones, these conventional arts are disadvantageous in that sounds of the wind instrument with the mute are different from sounds of the wind instrument without the mute, due to, for example, unnatural operation noise caused by manipulation of piston valves (operating elements) of the wind instrument uncomfortable noise caused by tonging, muffled (muted sounds caused by the mute, and disturbing high frequency noise. These disadvantages are caused by changes in frequency characteristic of sounds collected by the microphone due to the existence of the mute.

Although by the art disclosed in the above-described Japanese Unexamined Patent Publication No. 11-52836, electric signals supplied form the microphone are processed, the signal processing only controls the position of the sound image reproduced through the earphones and localized inside a head but does not correct the changes in frequency characteristic caused by the mute. Therefore, this art is also disadvantageous similarly to the other arts disclosed in Japanese Patent Publication Nos. 4114171, 4124236, 4521778, and Japanese Utility Model Registration No. 3145588.

The art resolved many distortions or disadvantageous noises from the wind instrument and mute collected through the embedded microphone in U.S. Pat. No. 9,251,744 B4. The art portrayed by the invention provided a signal processor for the wind instrument using a mute for reducing volume of a sound generated by the wind instrument. The signal processor circuit received an electrical signal which it cancelled, converted, and/or processed specific frequency characteristics of the sound caused by the instrument to enhance the electrical signal output.

The present invention was achieved an enhanced solution for the above ascribed problems. Our primary objective was to provide an acoustically designed internal chamber (ADIC) 300 for the Integrated Intelligent Silencer Mute Device (IISMD and outer casing) 200. Our secondary objective was to provide a circuit board 400 for the ISSMD 200 that would efficiently and effectively capture, cancel, process, transform and/or transfer the music frequencies derived from the instrument 100 and/or voice to technological devices (earphones and ear buds 501, mobile phones 502, tablets 503, laptops 504, and personal computers 505; monitors and smart televisions 506, servers 507, and cloud platforms 508). This process will allow a player or user of the instrument 100 or voice to listen to their sounds or sounds of other instruments or voices simultaneously within the IISMD 200 and/or within other electronic, digital, and technological devices. As for the descriptions for respective items of the present invention which facilitate this process, they are described in further detail below with numbers corresponding to components for easy understanding. Notwithstanding, the respective items and components of the present invention are and my not be limited to the corresponding items and components indicated by the number of the IISMD 200.

In this case, the IISMD 200 will be inserted into a bell 102 or attached to the music instrument (100: to include but not limited to woodwind: flute, clarinet, oboe, english horn, saxophone, bassoon; brass: trumpet, cornet, horn, trombone, baritone, euphonium, tuba; strings: violin, viola, cello, bass; percussion, and/or voices. The bell 102 of the woodwind instrument (WI) is the area or portion of the instruments that serves as the primary outlet for air and emission of sound or frequencies. The cylindrical diameter of a tube is broadened to enhance the increased volume and intensity of sound being emitted from the WI. The air originates from an individual player or user who inhales the air into the lungs and uses the diaphragmatic system to exhale the air through the mouth and lips. As the air leaves the lips in the mouthpiece, a node antinode process is forms which cause the air to produce waveforms. The cylindrical tubing compresses the waveforms while the valve system is depressed or released to shorten or lengthen the instrument to produce different notes or pitches.

The IISMD outer casing 200 is designed with a mute opening 201 that leads to an acoustically designed inner chamber (ADIC) 300. When inserted into the bell 102 or attached to the music instrument 100 facilitates the initial dampening and cancellation processes of distortions, disadvantageous sounds, and music frequencies emitted by the instrument. The IISMD is secured to the music instrument using three felt, plastic or rubber stops 202. The IISMD 200 can be manipulated to reduce or enhance the amount of sound frequencies emitted by the IISMD 200 and the music instrument. The dampening and cancellation process are further achieved by rotation of the compression release module 204 of the outer casing carousel 205 using the pegs 203 which open or close the four corresponding air release holes 206 which are aligned and associated with the outer tubes 301 of the ADIC 300 within the IISMD 200.

Within the IISMD outer casing 200 is the external skeleton for the ADIC 300 which has a small strut with openings 302 at the mute opening or anterior end. The small strut with openings encircles a large inner tube 303 with two small outer tubes 301. At the posterior end is a large strut with openings 304 which encircles the large inner tube 303 and also has inserts from the small outer tubes 301. At the posterior end of the IISMD 200 and ADIC 300 is the circuit board 400, circuit board housing, and universal serial bus (USB) port and adapter 207 and 407.

The microphone 401 which is embedded within the IISMD's circuit board 400 captures the sound frequencies performed by the individual player or user on the music instrument then transfers the sound frequencies and signal inputs to components on the circuit board 400. The circuit board also contains a central processing unit (CPU) microcontroller 402, fast fourier transform accelerator (FFTA) 403, digital signal processor (DSP) 404, audio card and amplifier 405, Wi-Fi and Bluetooth module 406; USB controller 407, and battery and battery charger 408.

The IISMD 200 is an Internet of Things (IoT) device. The circuit board 400 receives the sound frequencies via the microphone 401. The electrical signals are then cancelled, converted, and transformed via the audio card and amplifier 405, FFTA 403, sound image localization filter (SILF), global positioning system (GPS), and geographic information System (GIS) module 409; which are all processed and integrated within the CPU microcontroller 402.

The CPU microcontroller 402 will accomplish the signal processing, music instrument digital interfacing, sound and image stabilization and localization through coding, algorithms, and programming implemented within the CPU microcontroller 402. The CPU microcontroller 402 will receive and process the sounds and electrical signal filter coefficients and apply algorithms which will digitally enhance and transfer the processed digital information to technological devices (to include but not be limited to earphones and ear buds 501, mobile phones 502, tablets 503, laptops 504, and personal computers 505; monitors and smart televisions 506, servers 507, and cloud platforms 508.

Therefore, the sounds created by the individual player and instrument 100, global and centralized locations of the player are digitally identified, enhanced and transferred as electrical and digital signal outputs to the technological devices. The electrical and digital signal outputs from the IISMD 200 will be transferred to electronic, digital, and technological devices which have applications specifically designed to further collect, manipulate, control, and process the information across the Intelligently Integrated Technological System (IITS) 500. There will be mobile phone 502 applications that will directly be paired with the IISMD 200 via Bluetooth and Wi-Fi module 406 connections. The IISMD 200 will also have the capability to be connected to technological devices via USB 207 and 407 and other wired cable connections. Once paired digitally or wired the mobile phone 502 applications will connect t to the CPU microcontroller 402 of the IISMD 200 creating a network for the IITS 500. This process will also be available for other technological devices to include but not be limited to earphones and ear buds 501, tablets 503, laptops 504, and personal computers 505; monitors and smart televisions 506, servers 507, and cloud platforms 508. Specific applications designed for technological devices will be able to access the functions of the CPU microcontroller 402 within the ISSMD 200 further enhancing the overall IITS 500.

Further, the IITS 500 is a network and infrastructure that includes but is not limited to the ISSMD 200, Cloud platforms 508 and servers 507, domains, webpages, internet protocol, registry, coding (i.e., artificial intelligence, application programming interface), mobile phones 502, tablet computers 503, personal computers 505, ear buds and earphones 501, and smart televisions 506 which will collect, transfer and further process and store signals, data, and information received from the IISMD 200 and continuously processed and stored within the IITS 500.

In order to achieve the above-described object, process, and system which is a feature of the present invention to provide a CPU microcontroller 402 for use in the musical performance of music instruments within the IISMD 200 with an ADIC 300 for reducing volume of a sound generated by the music instrument 100. The circuit board 400 which processes and transforms sound frequencies and location information from a microphone 401, audio card and amplifier 405, FFTA 403, DSP 404, SILF, GPS, and GIS module 409; and processed within the CPU microcontroller 402.

The electrical signal received through the IISMD 200 via the microphone 401 is converted from analog to digital signal via the DSP 404 and CPU microcontroller 402. The sound frequencies generated within the IISMD 200 will be cancelled, converted, and transformed as a digital signal output via the FFTA 402 to electronic, digital, and technological systems and devices.

### BRIEF DESCRIPTION OF THE DRAWINGS

The accompanying drawings and figures illustrate a number of representations that are inclusive of and are a part of the Integrated Intelligent Silencer Mute Device (IISMD) 200 and Intelligently Integrated Technological System (IITS) 500 specifications. When viewed inclusively with the present description, these drawings demonstrate, describe, and explain various principles regarding this disclosure. A greater understanding of the nature and advantages of the present invention and innovation will be realized with reference to the drawings. With the attached or appended figures, similar Components, modules and/or features may have the same reference label.

FIG. 1A is a projected angular view of a trumpet having IISMD 200 according to a representation and embodiment of the present invention and innovation.

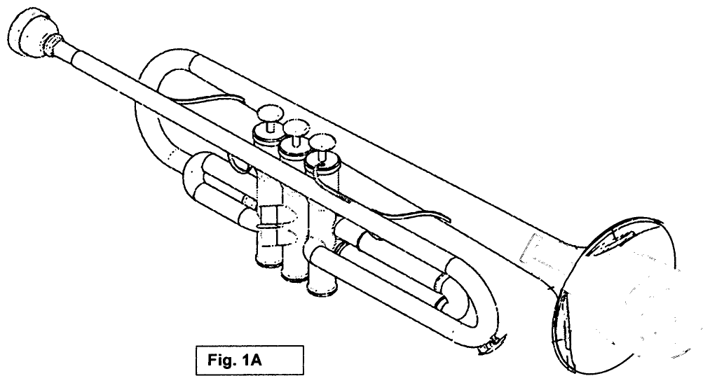

FIG. 1B is a projected angular and large external view of the IISMD 200 according to a representation and embodiment of the present invention and innovation.

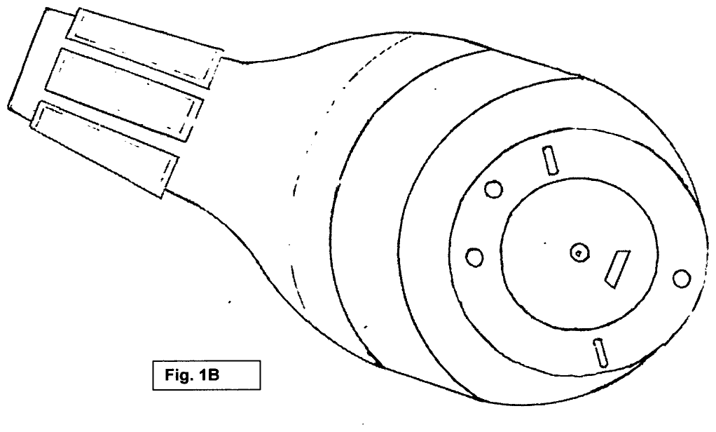

FIG. 2A is a side view of the trumpet and IISMD 200 of FIG. 1A.

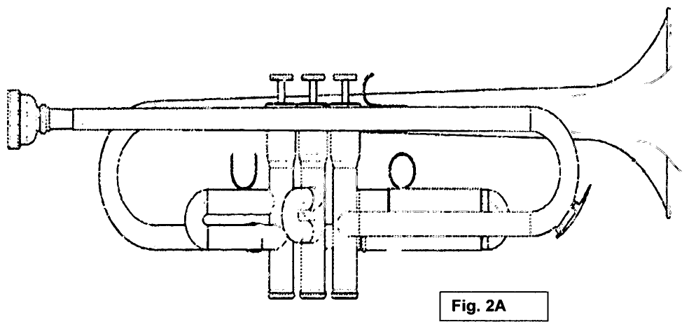

FIG. 2B is a rear view and perspective of the instrument bell and the IISMD 200 of FIG. 1B.

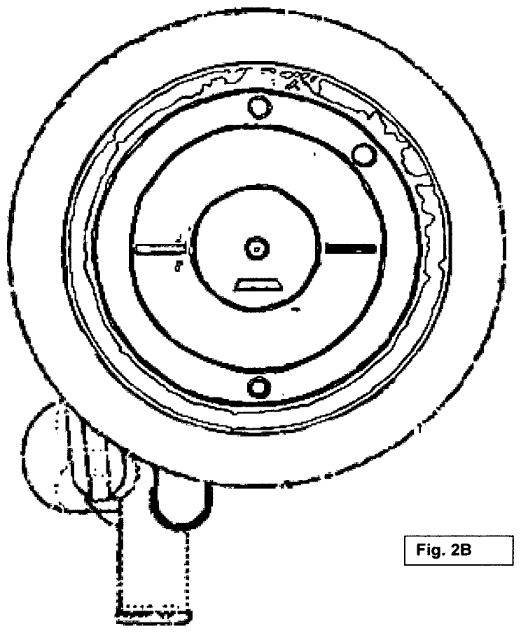

FIG. 3A is a projected side view perspective of the IISMD 200 according to a representation and embodiment of the present invention and innovation.

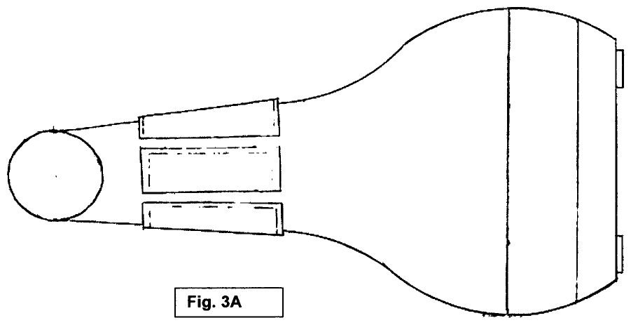

FIG. 3B is an exploded angular view of the IISMD 200 of FIG. 1B.

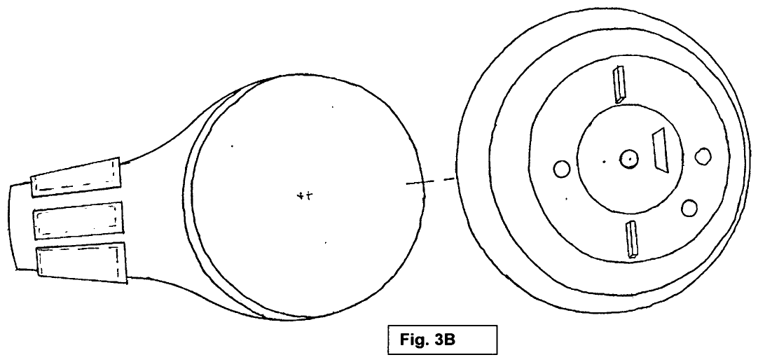

FIG. 4 is an exploded angular view, representation, and embodiment of the IISMD's 200 acoustically designed internal chamber for this present invention and innovation.

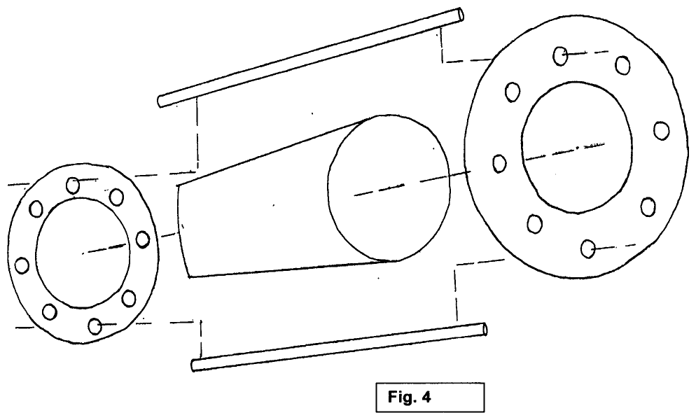

FIG. 5A is a block diagram of the circuit board and other components used in the mute according to another representation and embodiment of the present invention and innovation.

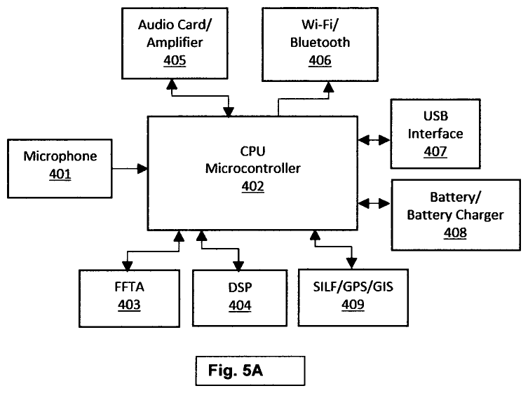

FIG. 5B is a block diagram of the circuit board and other technological components, modules, features, and devices used for integration and collaboration within the Intelligently Integrated Technological System (IITS) 500 according to another representation and embodiment of the present invention and innovation.

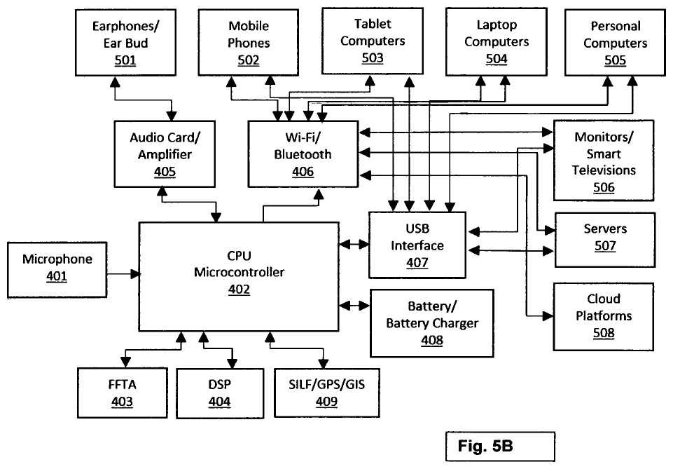

Notwithstanding, while the visual representations and embodiments described and displayed within this patent for an example of the invention and innovation, these demonstrations and examples are susceptible to various modifications and alternative forms. Specific representations and embodiments have been shown by way of example in the drawings and will be described in specific details within this publication. However, the exemplary representations and embodiments described herein are not intended to be limited to the particular forms disclosed. Conversely, the established and predicated disclosure covers all modifications, equivalents, and alternatives existing within the scope of the attached and appended claims.

1. An integrated intelligent music instrument and/or vocal mute system, body, and device that includes but is not limited to:
A. a mute body that is positioned or affixed within and/or in close proximity of a bell, horn or body of a music instrument or voice whereas the body or mouth is a proximal end portion or area that produces the highest intensity, volume or loudness and/or the body being configured to at least partially occlude or placed within the bell, horn, instrument and/or in close proximity of the voice or vocal area.
B. a microphone positioned at the posterior end portion of the mute body and configured to capture analog sounds produced by the music instrument and/or voice; a circuit board with microphone positioned within the posterior end of an acoustically designed internal chamber and embedded within the mute body; a DSP, FFTA, CPU microcontroller configured to receive and analog signal from the microphone to digital signals for streaming and transmission across high-speed networks via Bluetooth and Wi-Fi to intelligently integrated technological devices, components, and systems.

2. The music instrument mute of claim 1 whereas the mute body is partially conical and positioned within or in the proximity the bell or horn of the music instrument, voice and/or vocal area.

3. The music instrument mute of claim 1 whereas the mute body attaches to the music instrument using felt, plastic, rubber stops and/or rotatable ring for friction, interference, and/or negative pressure fit.

4. The music instrument mute of claim 3 whereas the rear casing located at the distal end is rotatable using the knobs of the shutter to open or close the corresponding holes that are aligned and associated with the outer tubes of the acoustically designed inner chamber of the mute system to facilitate dampening, cancellation and/or increased intensity or volume.

5. The music instrument mute of claim 3 whereas consists of an acoustically designed inner chamber of the mute system to facilitate dampening, cancellation and/or increased intensity or volume.

6. A music instrument mute body that attaches to a music instrument and/or position in close proximity that includes a microphone and circuit board; a central processing unit (CPU) microcontroller which connected to the microphone and circuit board which is configured to capture analog sound from instruments and voices and transmit the sounds and frequencies wirelessly to other technologically remote devices.

7. The music instrument mute of claim 1, further comprising a circuit boards with a digital signal processor and fast fourier transform accelerator, CPU microcontroller are configured to capture, modify and convert the analog sounds and frequencies into digital sounds and frequencies.

8. The music instrument mute of claim 1, further comprising Bluetooth and Wi-Fi modules that connects to the CPU microcontroller is configured to send and receive data across high-speed networks from other technological devices, components, and systems.

9. The music instrument mute of claim 1, further comprising Bluetooth and Wi-Fi modules that connects to the CPU microcontroller is configured to send and receive data using a USP module and port to and from other technological devices, components, and systems.

10. The music instrument mute system of claim 1 whereas the device comprises a sound image localization filter, global positioning system, and geographic information system module and sensors.

11. The music instrument mute system of claim 1 whereas the device comprises a battery and battery charger which are configured to supply electricity and recharge the device.
